(19) United States
(12) Patent Application Publication
(10) Pub. No.: US 2008/0002883 A1
(43) Pub. Date: Jan. 3, 2008

(54) System and method to recognize an optical character

(75) Inventor: Yang-moon Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/654,613

(22) Filed: Jan. 18, 2007

(30) Foreign Application Priority Data
Jun. 30, 2006 (KR) 2006-60684

(51) Int. Cl. G06K 9/18

(52) U.S. Cl. 382/182

(57) ABSTRACT

A system and a method of recognizing an optical character. The system to recognize an optical character includes an optical character recognition (OCR) unit to perform an OCR, and an application having a driving module to drive the OCR unit. Therefore, the number of complicated operations of obtaining an OCR print can be minimized.

### CROSS-REFERENCE TO RELATED APPLICATIONS

This application claims priority under 35 U.S.C. §119(a) from Korean Patent Application No. 10-2006-0060684, filed on Jun. 30, 2006, in the Korean Intellectual Property Office, the disclosure of which is incorporated herein in its entirety by reference.

### BACKGROUND OF THE INVENTION

1. Field of the Invention

The present general inventive concept relates to an optical character recognition (OCR), and more particularly, to a system and a method of recognizing an optical character to optimize the use of an OCR function by reducing the number of existing complicated operations of obtaining an OCR document.

2. Description of the Related Art

Recently, as digital documents have become more important, the necessity for an optical character recognition (OCR) has been increased. An OCR function is convenient to convert a large amount of documents into digital documents. That is, the OCR function is a function in which printed or handwritten characters are recognized by a computer and stored therein. The OCR function accompanies operations such as scanning a text, analyzing the text one character at a time, and translating a character image into a character code such as ASCII so that general data processing can be performed.

Operation of an OCR will now be described.

First, an OCR function is performed. Second, a scan driver is set. Third, a print is scanned using the scan driver, thereby obtaining an image. Fourth, the image is analyzed and is converted into an OCR document. Fifth, the layout of the OCR document is modified. Sixth, the modified OCR document is converted into a required format of the document, for example, into the format of MS-Word. Seventh, an application that corresponds to the format of the document, for example, MS-Word, is executed. Eighth, the converted OCR document is opened using the corresponding application and then necessary matters are modified.

However, as described previously, there are inconveniences that many operations should be performed so as to obtain the OCR document. In addition, since the OCR document is only generated in a new file, when a user wants to insert the OCR document while working with a pre-existing document in an application like MS-Word, complicated operations such as executing an additional corresponding application and then opening and editing the OCR document must be performed. There are also inconveniences in using a conventional system and a method to recognize an optical character.

### SUMMARY OF THE INVENTION

The present general inventive concept provides a system and a method to recognize an optical character in which the number of existing complicated operations of obtaining an OCR print is minimized.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a system to recognize an optical character, the system including an optical character recognition (OCR) unit to perform an OCR and an application having a driving module to drive the OCR unit.

The foregoing and/or other aspects of the present general inventive concept may also be achieved by providing a method of recognizing an optical character in an application having a driving module to drive an optical character recognition (OCR) unit to perform an OCR, the method including driving the OCR unit using the driving module.

The foregoing and/or other aspects and utilities of the present general inventive concept may also be achieved by providing a method of recognizing an optical character with the use of an optical character recognition (OCR) unit, the method including receiving setting information through a setting information inputting module, driving the OCR unit through the use of a driving module to recognize data on a document that is read by the OCR unit, reading the data that is read into the OCR unit through the use of an application, and manipulating the data that is read by the application.

The foregoing and/or other aspects and utilities of the present general inventive concept may also be achieved by providing a system to recognize an optical character, the system including an optical character recognition (OCR) unit to receive a document and perform an OCR function on the document, a driving module to instruct the OCR unit to perform the OCR function; and an application having a setting information inputting module to drive the driving module.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a system to recognize an optical character according to an embodiment of the present general inventive concept;

FIG. 2 illustrates an example of a module to recognize an optical character displayed on an application; and

FIG. 3 is a flow chart illustrating a method of recognizing an optical character according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

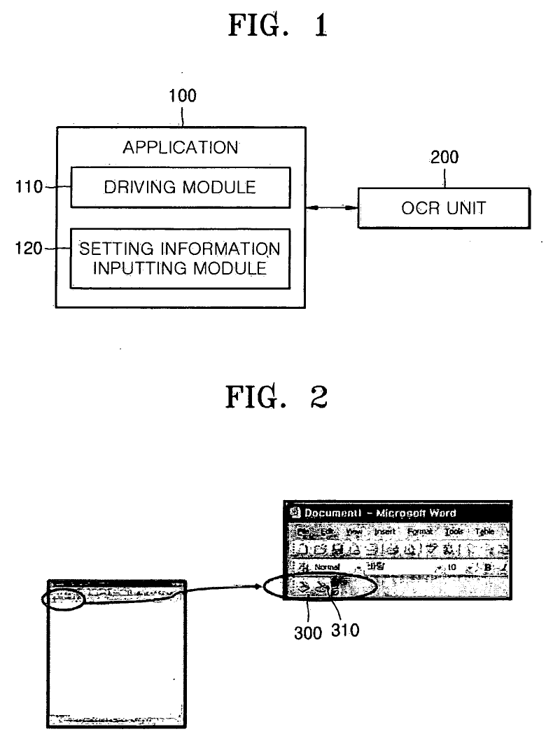

FIG. 1 is a block diagram of a system to recognize an optical character according to an embodiment of the present general inventive concept. The system to recognize an optical character illustrated in FIG. 1 includes an application 100 and an optical character recognition (OCR) unit 200. Here, the application 100 includes an application which processes characters, such as MS-Word. The application 100 includes a driving module 110 to drive the OCR unit 200. Here, the driving module 110 instructs the OCR unit 200 to perform an OCR function on the application 100. In particular, the driving module 110 uses a plug-in to drive the OCR unit 200. A plug-in is a hardware or software module that adds a specific feature or service to a larger system. More specifically, if an application is deficient regarding a function it may be reinforced by connecting a program to supplement the deficient function. Here, the plug-in enables the application 100 to drive the OCR unit 200 by use of the driving module, and then the OCR function performed by the OCR unit 200 occurs.

The driving module 110 is represented as an icon on a module of the application 100. FIG. 2 illustrates an example of the module of the application 100 that indicates an optical character on the application. Reference numeral 300 of the application illustrated in FIG. 2 denotes an icon which represents the driving module 110. If the icon 300 which represents the driving module 110 is selected in FIG. 2, the OCR unit 200 is driven by the selected driving module 110.

The application 100 may include a setting information inputting module 120 into which setting information for the OCR is input. The setting information inputting module 120 displays a dialogue window through which the setting information required to operate the OCR is input. The setting information inputting module 120 recognizes the setting information input by a user through the displayed dialogue window. The setting information that is through the setting information inputting module 120 includes information on scanning resolution, types of languages to recognize characters, and whether an image that excludes a detected character is displayed or not. The information on scanning resolution is used to set the setting information to represent that a document to be scanned will be scanned with a certain resolution. The information on types of languages to recognize characters is used to instruct the user to designate how the document to be scanned will be recognized, which characters will be used, and the type of language such as English, Korean, Japanese, Chinese, French, and German. Whether an image excluding a detected character is displayed or not is information to set whether only the detected character is displayed or whether the detected character and an image are displayed.

The setting information inputting module 120 is also represented as an icon on the application 100. Reference numeral 310 of the application illustrated in FIG. 2 denotes an icon which represents the setting information inputting module 120. If the icon of the setting information inputting module 120 illustrated in FIG. 2 is selected, a dialogue window through which the setting information that is input is displayed, and the setting information that is through the dialog window is recognized as setting information for an OCR.

The OCR unit 200 performs the OCR function on documents including information on printed or handwritten characters. The OCR unit 200 is driven by the driving module on the application 100 and performs the OCR function. The OCR unit 200 performs operations of scanning a print, analyzing the scanned result, and translating a character image into a character code such as ASCII, so that data processing can be performed, in accordance with the setting information set through the setting information inputting module 120. The OCR unit 200 then transmits data on which the OCR function has been performed, to the application 100.

The application 100 reads the data on which the OCR function has been performed, converts the recognized data to a form compatible with the application 100, and displays the converted data on a screen of the application 100. The user may edit the displayed data or may print the displayed data through a printing device.

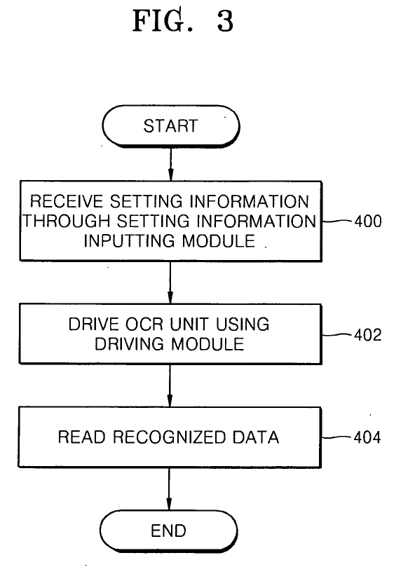

A method of recognizing an optical character will now be described with reference to FIG. 3.

FIG. 3 is a flow chart illustrating a method of recognizing an optical character according to an embodiment of the present general inventive concept. In operation 400, in an application 100 having a setting information inputting module 120 into which the setting information to recognize an optical character is input, the setting information is input through the setting information inputting module 120. The setting information inputting module 120 displays a dialogue window on which the setting information required for an OCR is input. The setting information inputting module 120 recognizes the setting information input by the user through the displayed dialogue window. The setting information that can be input through the setting information inputting module 120 includes a scanning resolution and types of languages to recognize characters. After operation 400 is performed, in the application 100 having a driving module to drive the OCR unit 200 to perform an OCR function, the OCR unit 200 is driven by the driving module in operation 402. In particular, the OCR unit 200 is driven using a plug-in. More specifically, the application 100 drives the OCR unit 200 using the driving module so that the OCR function performed by the OCR unit 200 is provided. After operation 402 is performed, the application 100 reads data recognized by the OCR unit 200 in operation 404. The read data is displayed on a screen of the application 100, and the user may edit or print the displayed data.

The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments to accomplish the present embodiment can be easily construed by programmers skilled in the art to which the present invention pertains.

As described above, in the system and method to recognize the optical character according to the present general inventive concept, the number of existing complicated operations of obtaining an OCR document is minimized such that users' convenience of use of the OCR unit is increased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system to recognize an optical character, the system comprising:
an optical character recognition (OCR) unit to perform an OCR; and
an application having a driving module to drive the OCR unit.

2. The system of claim 1, wherein the driving module drives the OCR unit through the use of a plug-in.

3. The system of claim 1, wherein the driving module is represented as an icon on the application.

4. The system of claim 1, wherein the application further includes a setting information inputting module into which setting information for the OCR is input.

5. The system of claim 4, wherein the setting information inputting module is represented as an icon on the application.

6. The system of claim 1, wherein the application converts and indicates data recognized by the OCR unit.

7. A method of recognizing an optical character in an application having a driving module to drive an optical character recognition (OCR) unit to perform an OCR, the method comprising driving the OCR unit using the driving module.

8. The method of claim 7, wherein the OCR unit is driven using a plug-in.

9. The method of claim 7, further comprising inputting setting information using a setting information inputting module in an application having the setting information inputting module to which the setting information for the OCR is inputted.

10. The method of claim 7, further comprising converting and indicating data recognized by the OCR unit.

11. A computer readable recording medium having recorded thereon a program to perform a method of recognizing an optical character in an application having a driving module to drive an optical character recognition (OCR) unit to perform an OCR, the method comprising driving the OCR unit using the driving module.

12. A method to recognize an optical character with the use of an optical character recognition (OCR) unit the method comprising:
receiving setting information through a setting information inputting module;
driving the OCR unit through the use of a driving module to recognize data on a document that is read by the OCR unit;
reading the data that is read into the OCR unit through the use of an application; and
manipulating the data that is read by the application.

13. A system to recognize an optical character, the system comprising:
an optical character recognition (OCR) unit to receive a document and perform an OCR function on the document;
a driving module to instruct the OCR unit to perform the OCR function; and
an application having a setting information inputting module to drive the driving module.
